(19) United States
(12) Patent Application Publication
(10) Pub. No.: US 2008/0214688 A1
(43) Pub. Date: Sep. 4, 2008

(54) SILICONE RUBBER SPONGE COMPOSITION

(76) Inventors: Satao HIRABAYASHI, Annaka-shi (JP); Yoshiaki KOIKE, Annaka-shi (JP)

Correspondence Address: BIRCH STEWART KOLASCH & BIRCH, PO BOX 747, FALLS CHURCH, VA, 22040-0747, US

(21) Appl. No.: 12/039,396

(22) Filed: Feb. 28, 2008

(30) Foreign Application Priority Data
Mar. 1, 2007 (JP) 2007-051803

(51) Int. Cl. C08J 9/14

(52) U.S. Cl. 521/95; 521/94

(57) ABSTRACT

A silicone rubber sponge composition comprising (A) an organopolysiloxane, (B) a non-cyano organic azo blowing agent which is thermally decomposable to cause thickening or curing of component (A), (C) an azodicarbonamide or dinitrosopentamethylenetetramine blowing agent, and (D) a curing agent is crosslinkable and expandable with atmospheric hot air. The composition makes it possible to freely control the blowing magnification and the cell size of the resulting sponge, enabling to form a fully expanded silicone rubber sponge with crosslinked surface. The sponge free of cyano compounds is least toxic.

### CROSS-REFERENCE TO RELATED APPLICATION

This non-provisional application claims priority under 35 U.S.C. §119(a) on Patent Application No. 2007-051803 filed in Japan on Mar. 1, 2007, the entire contents of which are hereby incorporated by reference.

### TECHNICAL FIELD

This invention relates to silicone rubber sponge compositions for forming silicone rubber sponges which are useful as building gaskets, various sponge sheets, industrial rolls, sponge rolls in copiers and other business machines, heat insulating sheets and the like.

### BACKGROUND ART

Silicone sponges have physical properties inherent to silicone rubber and exhibit improved properties including heat resistance, freeze resistance, electric insulation, flame retardance, and compression set. Such silicone rubber sponges are generally obtained by combining a thermosetting silicone rubber composition with a curing agent and a blowing agent and heating for expansion and curing. The key factors in the sponge forming process include effective expansion, a uniform fine cellular structure, a skin layer having a smooth and tack-free surface, and retention of physical properties inherent to silicone rubber.

The working and molding method employed for silicone sponges is most often curing and expansion in atmospheric hot air, which enables continuous molding. To form a sponge of uniform fine cellular structure by molding in atmospheric hot air, the gas resulting from decomposition of a blowing agent must be confined within the rubber as fine bubbles. Typically prior to the decomposition of the blowing agent, the rubber composition must thus have thickened and cured to such an extent as to restrain the blowing pressure.

During the sponge molding process, reactions generally take place within the silicone rubber in the following sequence:
1) organopolysiloxane component to form silicone rubber sponge thickens or cures with a curing agent, and
2) blowing agent is decomposed to evolve gas.

In practice, the amount of addition crosslinking catalyst is adjusted for reaction control so that reactions take place in the above sequence. Alternatively, the organic peroxide is selected to have a decomposition temperature equal to or lower than the decomposition temperature of the blowing agent so as to provide the above reaction sequence.

However, controlling the initial cure of rubber is very difficult. In the case of addition crosslinking, the parameter may vary from batch to batch depending on the amount of inhibitor and the strength of catalyst. In the case of organic peroxide crosslinking, an organic peroxide compliant with the decomposition temperature of a blowing agent must be sought, and the decomposition behavior in the overall temperature range where sponge is molded must be identical for both the blowing agent and the organic peroxide. In either case, extremely delicate control is necessary.

For the expansion of silicone rubber sponge, azoisobutyronitrile (AIBN) is traditionally most often used as the blowing agent. Because of many advantages including evolution of more nitrogen gas per molecular weight, full expansion of sponge with a less addition amount, and an unlikelihood of becoming inhibitory to addition reaction, AIBN is used in both the cure systems of organic peroxide crosslinking and addition reaction crosslinking. However, AIBN has the inconvenience that gases resulting from its decomposition are undesired for safety and hygiene, and an attempt to completely remove the gases entails a long time of post cure. There is a desire to have a safe blowing agent.

A variety of substances are under investigation as the non-AIBN blowing agent applicable to silicone. Among such blowing agents, inorganic salts such as sodium hydrogencarbonate are disclosed in JP-A 5-156061, JP-A 2006-083237, and JP-A 2006-193609. However, sponge compositions comprising sodium hydrogencarbonate as the blowing agent are inconsistent in cell shape and blowing magnification because they lack the reproductivity of sponge cell shape, and abnormal expansion occurs depending on the water content of rubber compound. Another problem is that the decomposition product, sodium carbonate can be left within the rubber.

Typical organic blowing agents proposed so far include amine-derived organic azo compounds such as azodicarbonamide (ADCA) and nitroso compounds such as N,N′-dinitrosopentamethylenetetramine (DPT) (see JP-A 55-29566 which is cited as a prior art in Japanese Patent No. 3133401). With these blowing agents, however, little or no expansion occurs when they are merely incorporated in silicone rubber compounds and allowed to expand in hot air (i.e., HAV molding) as in the case of AIBN. The reason is that their decomposition temperature is as high as 140° C. to 250° C. Then, control of crosslinking is difficult in addition crosslinking systems. In organic peroxide crosslinking systems having a narrow range of decomposition temperature, control of crosslinking is difficult as well, and silicone rubber compounds having a low polymer viscosity prior to crosslinking fail to restrain the blowing pressure during high temperature HAV. The resulting sponges are inferior in surface smoothness due to gas escape and abnormal expansion, and have surfaces which remain more or less tacky. The methods of producing sponge through HAV crosslinking using ADCA or DPT include (1) a method of using as the base polymer a silicone polymer in which 1-ethyl-1-butynyl or ethylidenenorbornyl groups are used as the crosslinking group instead of traditional vinyl groups (see JP-A 2-016132), (2) a method of using as the base polymer a silicone polymer in which cycloalkyl groups such as cyclohexyl are used as the crosslinking group (see JP-A 2-251542), and a method of using as the base polymer a polyorganosiloxane having a hydrocarbon group of 4 or more carbon atoms including at least one active tertiary carbon as the silicon-bonded organic group (see Japanese Patent 3133401). Although these methods can form sponge through HAV, they have drawbacks including an increased cost because the base polymers are of special structure, and a low modulus and poor compression set as compared with dimethylpolysiloxane.

### DISCLOSURE OF THE INVENTION

An object of the invention is to provide a silicone rubber composition which is efficient in atmospheric hot air crosslinking without a need for careful control of the crosslinking rate of organopolysiloxane to form silicone rubber sponge or a delicate combination of foam and organic peroxide; which can form a fully expanded silicone rubber sponge having a uniform fine cell structure and a skin layer with a smooth surface; and which can readily produce a safe sponge, for the decomposition gas of the blowing agent is free of toxic cyano compounds.

The inventor has found that by using a non-cyano organic azo blowing agent which can cause thickening of an organopolysiloxane (or silicone polymer) and has a higher decomposition temperature than the amine-derived organic azo blowing agents, typically 1,1′-azobis(cyclohexane-1-methyl carboxylate) and an azodicarbonamide or dinitrosopentamethylenetetramine organic blowing agent (provided that sodium hydrogencarbonate is excluded as the blowing agent), and subjecting a silicone rubber sponge composition to atmospheric hot air vulcanization, a fully expanded silicone rubber sponge with uniform cell shape is obtainable in a reproducible manner; and that the decomposition gas of the blowing agent is cyano-free and has minimized toxicity to the human body so that the silicone rubber sponge can be produced and used in a safe manner.

The invention provides a silicone rubber sponge composition comprising

(A) 100 parts by weight of an organopolysiloxane having the average compositional formula (I):

R¹ₐSiO_{(4-a)/}_{²} (I)

wherein R¹ is each independently a substituted or unsubstituted monovalent hydrocarbon group and “a” is a positive number of 1.95 to 2.04,

(B) 0.1 to 20 parts by weight of a non-cyano organic azo blowing agent which is thermally decomposable to cause thickening or curing of component (A),

(C) 1 to 50 parts by weight of an azodicarbonamide blowing agent and/or dinitrosopentamethylenetetramine blowing agent, and

(D) a curing agent.

The composition is crosslinkable and expandable with atmospheric hot air.

In one preferred embodiment, the non-cyano organic azo blowing agent (B) is such that when a mixture of 100 parts by weight of component (A) and 3 parts by weight of component (B) is heated at 170° C. so that component (B) is thermally decomposed, the mixture becomes an organic foam having a buildup of Mooney viscosity ML₁₊₄ of at least 100% over the Mooney viscosity of component (A) alone.

In another preferred embodiment, the non-cyano organic azo blowing agent (B) comprises 1,1′-azobis(cyclohexane-1-methylcarboxylate).

In a further preferred embodiment, the composition further comprises a kicker for facilitating decomposition of component (C) selected from the group consisting of urea, zinc oxide, an organic zinc compound, and mixtures thereof.

In a further preferred embodiment, the curing agent (D) is an addition reaction curing agent consisting of a hydrosilylation catalyst and an organohydrogenpolysiloxane, an organic peroxide, or a combination of an addition reaction curing agent and an organic peroxide.

Optionally, the composition may further comprise (E) 1 to 60 parts by weight of conductive carbon for rendering the composition electrically conductive.

Typically, the composition is cured to form a fully expanded silicone rubber sponge having a low density equal to or less than 0.3 g/cm³.

### BENEFITS OF THE INVENTION

The use of components (B) and (C) as the blowing agent in the silicone rubber sponge composition makes it possible to freely control the blowing magnification and the cell size of the resulting sponge, enabling to form a fully expanded silicone rubber sponge with a fully crosslinked surface. The sponge is free of cyano compounds and thus least toxic. The silicone rubber sponge finds use as gaskets such as building gaskets, electronic equipment packing and automotive weather strips, rolls such as fixing rolls in business machines and semi-conductive rolls in printers (especially toner feed rolls), household packing, cosmetic puffs, shock absorbers, and the like.

### DESCRIPTION OF THE PREFERRED EMBODIMENT

The present invention may be understood more readily by reference to the following detailed description of preferred embodiments of the invention and the examples included therein. In the following specification and the claims which follow, reference will be made to a number of terms which shall be defined to have the following meanings:

The terms “thickening” and “a viscosity buildup” are used interchangeably herein. The term “conductive” is electrically conductive unless otherwise stated. “HAV” is the abbreviation of hot air vulcanization or crosslinking, and “pbw” is the abbreviation of parts by weight.

The organopolysiloxane used herein as component (A) has the average compositional formula (I):

R¹ₐSiO_{(4-a)/}_{²} (I)

wherein R¹ is each independently a substituted or unsubstituted monovalent hydrocarbon group and “a” is a positive number of 1.95 to 2.04.

In formula (I), R¹ may be the same or different and is selected from monovalent hydrocarbon groups. Exemplary of R¹ are substituted or unsubstituted monovalent hydrocarbon groups of 1 to 12 carbon atoms, preferably 1 to 6 carbon atoms including alkyl groups such as methyl, ethyl, propyl, butyl, hexyl, and dodecyl; cycloalkyl groups such as cyclohexyl; alkenyl groups such as vinyl, allyl, butenyl and hexenyl; aryl groups such as phenyl and tolyl; aralkyl groups such as β-phenylpropyl; and substituted forms of the foregoing in which some or all carbon-bonded hydrogen atoms are replaced by halogen atoms, cyano groups or the like, such as chloromethyl, trifluoropropyl, and cyanoethyl. The letter “a” is a positive number from 1.95 to 2.04. The organopolysiloxane may be capped at the ends of its molecular chain with trimethylsilyl, dimethylvinyl, dimethylhydroxysilyl, trivinylsilyl or similar groups. The organopolysiloxane should have at least two alkenyl groups in the molecule, and preferably 0.001 to 5 mol %, and more preferably 0.01 to 0.5 mol % of R¹ is alkenyl groups, especially vinyl groups.

The organopolysiloxane of this type may generally be prepared through (co)hydrolytic condensation of one or more selected organohalogenosilane or through ring-opening polymerization of a cyclic polysiloxane (e.g., trimer or tetramer of siloxane) in the presence of an alkaline or acidic catalyst. It is basically a linear diorganopolysiloxane while it may be partially branched. A mixture of two or more organopolysiloxanes of different molecular structure is also acceptable.

The organopolysiloxane should preferably have a kinematic viscosity of at least 100 mm²/s at 25° C. and more preferably 100,000 to 10,000,000 mm²/s at 25° C., as measured by an Ostwald viscometer. Also preferably, it has an average degree of polymerization of at least 100, more preferably at least 3,000, and the upper limit is preferably 100,000, and more preferably 10,000. The average degree of polymerization is determined from a calibration curve drawn from data measured by gel permeation chromatography (GPC) versus polystyrene standards.

Component (B) is a non-cyano organic azo blowing agent which is thermally decomposable to cause thickening or curing of component (A). The non-cyano organic azo blowing agent which is so characterized can not only evolve a gas as a result of its decomposition, but also induce crosslinking reaction of methyl and alkenyl groups present in the molecule of organopolysiloxane (A) by way of radical reaction, thereby achieving a build-up of polymer viscosity.

Therefore, where the organic azo blowing agent that brings thickening as defined herein is used, “thickening (or curing) of component (A) by a curing agent” and “gas evolution resulting from decomposition of a blowing agent” occur substantially simultaneously within the rubber during sponge molding. This allows for a free choice of crosslinking agent for better physical properties (e.g., hardness and permanent set) of silicone rubber sponge without a need to adjust the amount of addition crosslinking catalyst for controlling reaction and independently of the decomposition temperature of organic peroxides. Because crosslinking occurs at the same time as decomposition of the blowing agent, the sponge molding temperature covers a very broad range from low to high temperatures within which stable sponge can be molded. This allows for not only curing of sponge in atmospheric hot air, but also formation of stable foam within a restricted space as in the case of pressure expansion or expansion within a cylindrical tube.

In general, azo compounds are frequently used as a radical polymerization agent for vinyl compounds, and are believed to function as a similar polymerization agent for alkenyl groups (sometimes referred to as “Si-Vi”) in the molecule of organopolysiloxane. Nevertheless, in fact, few blowing agents can generate a strong radical enough to achieve a viscosity buildup when added in such amounts as ordinary blowing agents are used, or can induce a viscosity buildup at the same time as decomposition thereof. Specifically, for azobisisobutyronitrile, 2,2-azobis-2-methylbutyronitrile, 2,2′-azobis-2,4-dimethylvaleronitrile, 1,1′-azobis(1-acetoxy-1-phenylethane) and the like, any quick viscosity build-up associated with their decomposition is not observed.

Quite unexpectedly, the inventors have found those non-amino organic azo blowing agents of the nature that when they are thermally decomposed, they can cause thickening or curing of component (A), organopolysiloxane. Desirably the non-cyano organic azo blowing agent (B) is such that when a mixture of component (A) and blowing agent (B) is heated at or above the thermal decomposition temperature of blowing agent (B) so that blowing agent (B) is decomposed to generate a radical which causes thickening of component (A), the mixture experience a viscosity build-up of at least 50% and more desirably at least 100% over the viscosity of component (A) alone when heated under the same conditions. More specifically, the non-cyano organic azo blowing agent (B) is desirably such that when a mixture of 100 parts by weight of component (A) and 3 parts by weight of component (B) is heated at 170° C. so that component (B) is thermally decomposed, the Mooney viscosity ML₍₁₊₄₎ of the mixture marks a buildup of at least 100% and more desirably at least 150% over the Mooney viscosity of component (A) alone.

Examples of the non-cyano organic azo blowing agent possessing the above nature include 1,1′-azobis(cyclohexane-1-methylcarboxylate) and 2,2′-azobis[N-(2-propenyl)-2-methylpropionamide]. Best results are obtainable with 1,1′-azobis(cyclohexane-1-methylcarboxylate).

The organic blowing agent (B) is added in an amount of 0.1 to 20 parts, and preferably 0.5 to 10 parts by weight per 100 parts by weight of component (A). Less than 0.1 pbw of component (B) leads to insufficient expansion. More than 20 pbw of component (B) exerts too much a thickening effect on the polymer component, resulting in inhibited expansion, uneven expansion, cell breakage, non-elastic sponge, or an aesthetically unacceptable skin layer.

In the composition of the invention, an azodicarbonamide (ADCA) and/or dinitrosopentamethylene-tetramine (DPT) blowing agent is used as the main blowing agent (C). Both the blowing agents give a substantial gas yield, specifically azodicarbonamide and dinitrosopentamethylenetetramine having a gas yield of 270 and 260 ml/g, respectively, and have a decomposition temperature as high as about 200° C. to about 210° C. Also, the blowing agents can be readily modified so as to have a lower decomposition temperature of about 120 to about 170° C. by combining a kicker therewith. Additionally, the blowing agents do not contain in their molecule sulfur compounds or phosphate salts capable of substantially interfering with cure of organopolysiloxane. For these reasons, these blowing agents are advantageously used in the invention.

Component (C), azodicarbonamide or dinitrosopentamethylenetetramine, is added in an amount of 1 to 50 parts, and preferably 2 to 30 parts by weight per 100 parts by weight of component (A). The blowing agent used herein may be azodicarbonamide alone, dinitrosopentamethylenetetramine alone or a mixture of azodicarbonamide and dinitrosopentamethylenetetramine. The decomposition temperature of these blowing agents can be reduced by combining suitable kickers therewith. As used herein, the term “kicker” refers to an auxiliary agent which facilitates decomposition of a blowing agent for thereby lowering the decomposition temperature thereof. For the azodicarbonamide blowing agent, suitable kickers include urea-based systems (e.g., urea and urea-containing fillers), zinc oxide (e.g., zinc white and conductive zinc oxide), and organic zinc compounds. (e.g., zinc compounds with Lewis acids, and zinc stearate). For the dinitrosopentamethylenetetramine blowing agent, suitable kickers are urea-based systems. The decomposition temperature of the main blowing agent can be adjusted with the amount of kicker added, and desirably so as to fall in a range of 120° C. to 170° C. The amount of kicker added is typically 0.1 to 8.0 parts and more typically 0.5 to 5.0 parts by weight per 10 parts by weight of the blowing agent. The addition of blowing agent (C) ensures formation of sponge featuring a full expansion and a low density. If the amount of blowing agent (C) is more than 50 pbw per 100 parts by weight of component (A), too large an amount of blowing gas evolves to cause sponge fissure, and an amine compound as the decomposition product is inhibitory to addition crosslinking, reducing surface crosslinking and allowing for gas escape. In the context of the invention, sodium hydrogencarbonate is excluded from the blowing agent.

While component (A) has been crosslinked, thickened and expanded by components (B) and (C), a curing agent as component (D) is used in an auxiliary manner to drive the cure of component (A) to completion.

The curing agent is not particularly limited as long as it can induce curing of component (A). In general, known curing agents commonly used in ordinary silicone rubber compositions may be used including (1) a crosslinking reaction system using an organohydrogenpolysiloxane and a platinum group metal based catalyst for addition reaction and (2) a crosslinking system using an organic peroxide vulcanizing agent. A combination of the addition reaction crosslinking system with the organic peroxide vulcanizing agent is desirable herein.

For crosslinking reaction system (1) based on addition reaction, the organopolysiloxane used as component (A) should be an organopolysiloxane wherein at least one of organic groups R¹ bonded to silicon atoms in the molecule is an alkenyl group, especially vinyl.

The addition reaction catalyst may be any of well-known ones including platinum group metals alone and compounds thereof. Illustrative examples include microparticulate platinum metal adsorbed on such carriers as silica, alumina and silica gel, platinic chloride, chloroplatinic acid, complexes of chloroplatinic acid hexahydrate with olefins or divinyldimethylpolysiloxane, alcohol solutions of chloroplatinic acid hexahydrate, palladium catalysts, and rhodium catalysts. The catalyst may be used in a catalytic amount, and specifically in an amount of 1 to 1,000 ppm, and more specifically 10 to 100 ppm of platinum group metal based on the weight of component (A). Less than 1 ppm may be too small to promote crosslinking reaction, resulting in under-cure. Addition of more than 1,000 ppm exerts little extra effect on reactivity and is uneconomical.

The crosslinking agent for addition reaction is an organohydrogenpolysiloxane having at least two SiH groups in the molecule. It may be straight, cyclic or branched. Use may be made of any well-known organohydrogenpolysiloxanes commonly used as the curing agent in addition reaction curing silicone rubber compositions. Typically, it has the average compositional formula (II):

R⁴ₓH_{y}SiO_{(4-x-y)/}_{²} (II)

wherein R⁴ is a substituted or unsubstituted monovalent hydrocarbon group like R¹, preferably of 1 to 12 carbon atoms, and more preferably 1 to 8 carbon atoms, including alkyl, aryl and aralkyl groups and halo- and cyano-substituted forms thereof, and preferably free of aliphatic unsaturation; x and y are positive numbers satisfying 1≦x≦2.2, 0.002≦y≦1, and 1.002≦x+y≦3. In the molecule, at least two, and preferably at least three SiH groups are present and may be located at the ends or any intermediate positions of the molecular chain. The organohydrogenpolysiloxane should preferably have a viscosity equal to or less than 300 cs at 25° C.

The organohydrogenpolysiloxane is incorporated in an amount of 0.01 to 10 parts by weight per 100 parts by weight of the organopolysiloxane (A). Preferably the organohydrogenpolysiloxane is used in such amounts that 0.5 to 10 and more preferably 1 to 4 silicon-bonded hydrogen atoms are available per alkenyl group in component (A). If the number of silicon-bonded hydrogen atoms is less than 0.5, then crosslinking may be insufficient to achieve mechanical strength. If the number of hydrogen atoms is more than 10, then the cured product may have poor physical properties, and specifically, be substantially degraded in heat resistance and compression set. Besides, well-known platinum catalyst inhibitors such as polymethylvinylsiloxane cyclic compounds, acetylene-containing alcohols and peroxides are preferably added to the silicone rubber composition.

In crosslinking system (2), suitable organic peroxide vulcanizing agents include benzoyl peroxide, bis-2,4-dichlorobenzoyl peroxide, bis-4-methylbenzoyl peroxide, bis-2-methylbenzoyl peroxide, 2,4-dimethylbenzoyl peroxide, 1,6-bis(p-toluoylperoxycarbonyloxy)butane; 1,6-bis(2,4-dimethylbenzoyl peroxycarbonyloxy)hexane, 2,5-dimethyl-2,5-di-t-butylperoxyhexane, t-butyl peroxybenzoate, dicumyl peroxide, cumyl-t-butyl peroxide, 1,6-bis(t-butylperoxycarbonyloxy)hexane, and other peroxides. Where HAV is desired, the preferred peroxides include diacyl organic peroxides such as bis(2,4-dichlorobenzoyl) peroxide and 4-methylbenzoyl peroxide, halogen-free, alkyl-substituted benzoyl peroxides and other benzoyl peroxides described in JP-A 10-182972, 1,6-bis(p-toluoyl peroxycarbonyloxy)hexane, and 1,6-bis(t-butylperoxycarbonyloxy)hexane. These organic peroxides may be used alone or in admixture.

The organic peroxide is incorporated in an amount of 0.01 to 50 parts, and preferably 0.5 to 10 parts by weight per 100 parts by weight of organopolysiloxane (A). Less than 0.01 pbw of the organic peroxide may provide short cure. More than 50 pbw may achieve no further improvement in curing rate and require a time-consuming removal of unreacted reactant or decomposed residues.

A combination of the organic peroxide with the addition reaction curing agent and organohydrogenpolysiloxane used in addition reaction-route crosslinking reaction, that is, crosslinking reaction having crosslinking reaction systems (1) and (2) combined together is recommended as the crosslinking agent used in the invention. Although the addition crosslinking agent is effective in improving surface crosslinking with hot air during HAV molding of rubber in a relatively low temperature region, the amine compound resulting from decomposition of ADCA becomes an addition crosslinking inhibitor which invites a loss of cure. The organic peroxide is added to compensate for this loss, resulting in a fully elastic sponge.

The composition of the invention has the sponge expansion mechanism characterized in that the respective additives have their own individual distinct functions for sponge production, specifically component (B) for thickening component (A) and controlling initial formation of sponge cells, component (C) for increasing the amount of blowing gas evolved, and component (D) for complete crosslinking. This ensures efficient production of a fully expanded, low hardness sponge, especially a sponge with a density equal to or less than 0.3 g/cm³, particularly when the blowing agent as component (C) is added in a larger amount. In particular, the sponge density can be reduced to or below 0.15 g/cm³. The sponge should preferably have a density equal to or more than 0.05 g/cm³. It is noted that the sponge density is measured according to JIS K-6249.

The sponge may be made conductive by adding (E) conductive carbon to the composition. The type and amount of conductive material are not particularly limited. Any well-known conductive carbon black may be used.

The carbon black used herein may be selected from those customarily used in conventional conductive rubber compositions, and examples include acetylene black, conductive furnace black (CF), super-conductive furnace black (SCF), extra-conductive furnace black (XCF), conductive channel black (CC), and furnace black and channel black which have been heat treated at elevated temperatures of about 1,500 to 3,000° C. Specific examples include acetylene blacks sold under the trade name of Denka Black from Denki Kagaku Kogyo K.K. and Shawnigan Acetylene Black from Shawnigan Chemical Co.; conductive furnace blacks sold under the trade name of Continex CF from Continental Carbon and Vulcan C from Cabot Corp.; super-conductive furnace blacks sold under the trade name of Continex SCF from Continental Carbon and Vulcan SC from Cabot Corp.; extra-conductive furnace blacks sold under the trade name of Asahi HS-500 from Asahi Carbon Co., Ltd. and Vulcan XC-72 from Cabot Corp.; and conductive channel black sold under the trade name of Corax L from Degussa AG. Also included are those carbon blacks prepared by an oil combustion process not including a quenching step (known as MMM process) and marketed under the trade name of ENSACO 260G, ENSACO 250G, and ENSACO 210G from TIMCAL Co. Ketjen Black EC and Ketjen Black EC-600JD (Ketjen Black International) which belong to a class of furnace black are also useful. The furnace black should desirably contain impurities in a low concentration, specifically sulfur and sulfur compounds in a concentration equal to or less than 6,000 ppm, more preferably equal to or less than 3,000 ppm of elemental sulfur. Of these carbon blacks, acetylene black is more conductive because of a low impurity content and a well developed secondary structure, and thus especially suited for use herein. Also Ketjen Black EC-300JD and Ketjen Black EC-600JD are advantageously used because they exhibit good conductivity even at low loadings for their outstanding specific surface area.

Also useful are carbon fibers prepared by carbonizing carbonaceous filaments. Such carbon fibers have a diameter of 0.1 μm to 10 μm and a length of 5 μm to 1,000 μm. Carbon nanotubes synthesized by evaporating carbon by an arc or laser may be used. The carbon nanotubes may be either single wall or multi-wall carbon nanotubes while they have a diameter of 0.5 nm to 2.0 nm and a length of 1 nm to 1,000 nm.

The conductive carbon black is preferably added in an amount of 1 to 60 parts, and more preferably 5 to 40 parts by weight per 100 parts by weight of component (A). Less than 1 pbw of carbon black may fail to provide the desired conductivity. More than 60 pbw of carbon black may interfere with physical mixing and detract from mechanical strength, failing to achieve the desired rubber elasticity.

Where it is desired to obtain a non-black color conductive sponge, a particulate conductive metal oxide such as conductive zinc white or conductive titania may be used instead of carbon black. Such conductive materials may be used alone or in admixture of two or more. Examples of non-black color particulate conductive metal oxide include conductive zinc white, titania and tin-antimony particulate. For example, conductive zinc oxide is commercially available as Zinc Oxide 23-K from Hakusui Tech Co., Ltd. and conductive zinc white FX from Honjo Chemical Corp.; and white conductive titania is commercially available as ET-500W from Ishihara Industry Co., Ltd. These particulates are added in an amount of 1 to 300 parts by weight per 100 parts by weight of component (A) for imparting the desired electric resistance to the composition while they may be optionally used in combination with carbon.

To the silicone rubber sponge composition of the invention, reinforcing silica fine powder is desirably added. The reinforcing silica fine powder is necessary to produce a silicone rubber sponge with good mechanical strength and to this end, should have a specific surface area of at least 50 m²/g, and preferably 100 to 400 m²/g. Exemplary of the silica fine powder are fumed silica (dry silica) and precipitated silica (wet silica), with the fumed silica being preferred. Silica particles may be surface treated with organopolysiloxanes, organopolysilazanes, chlorosilanes, alkoxysilanes or the like to be hydrophobic. The silicas may be used alone or in admixture. The silica fine powder is desirably added in an amount of 5 to 100 parts, more desirably 10 to 90 parts, and even more desirably 30 to 80 parts by weight per 100 parts by weight of organopolysiloxane (A). Less than 5 pbw of silica per 100 pbw of component (A) is too small to achieve the desired reinforcement whereas more than 100 pbw may adversely affect compound working and the physical properties of silicone rubber sponge.

In the silicone rubber sponge composition, various other additives may be added if necessary, including non-reinforcing silica such as ground quartz and diatomaceous earth, fillers such as calcium carbonate, colorants, heat resistance improvers, flame retardants, acid acceptors, heat conductive agents, mold release agents, and dispersants such as alkoxysilanes, diphenylsilane diols, carbon functional silanes, and silanol end-capped low molecular weight siloxanes.

The silicone rubber sponge composition may be prepared by mixing the foregoing components on a rubber kneading machine such as a two-roll mill, Banbury mixer, dough mixer or kneader until the composition is uniform.

From the silicone rubber sponge composition thus prepared, a silicone rubber sponge may be readily obtained through a heating, expanding and curing step. The curing and expanding step may be achieved by applying heat sufficient to induce decomposition of the blowing agent and vulcanization of silicone rubber. The molding method may be preferably extrusion molding concomitant with continuous HAV crosslinking, or calendering followed by atmospheric HAV, typically batchwise HAV crosslinking. In these cases, the heating temperature is preferably in a range of 100 to 500° C. and more preferably 150 to 400° C., and the time is several seconds to 1 hour and more preferably 10 seconds to 30 minutes. If necessary, secondary vulcanization may be carried out at 180 to 250° C. for about 1 to 10 hours for the purpose of removing the decomposition product of blowing agent and low molecular weight silicone fluid.

### EXAMPLE

Examples of the invention are given below by way of illustration and not by way of limitation. All parts are by weight.

### Example 1

To 100 parts of a thermosetting silicone rubber compound loaded with about 30% by weight of particulate reinforcing silica (trade name KE-551-U by Shin-Etsu Chemical Co., Ltd., solid rubber density 1.14), were added 3 parts of 1,1′-azobis(cyclohexane-1-methylcarboxylate) and 4.0 parts of azodicarbonamide as the blowing agent, and 1.0 part and 2.0 parts of addition crosslinker C-25A and C-25B, respectively, as the crosslinking agent. The ingredients were kneaded on a two-roll mill and shaped into a sheet of 5 mm thick. The sheet was heated at 230° C. for 15 minutes. The sponge thus obtained was subjected to secondary vulcanization or post-cure at 200° C. for 4 hours. The sponge state was observed and it was measured for hardness (Asker C) and density (g/cm³, JIS K-6249).

### Example 2

A sponge was produced as in Example 1 except that 4.0 parts of dinitrosopentamethylenetetramine was used instead of 4.0 parts of azodicarbonamide as the blowing agent.

### Example 3

A sponge was produced as in Example 1 except that 4.0 parts of azodicarbonamide which had been modified with urea to have a lower decomposition temperature of 150° C. was used instead of 4.0 parts of azodicarbonamide as the blowing agent.

### Example 4

A sponge was produced as in Example 1 except that 4.0 parts of azodicarbonamide which had been modified with an organic zinc compound to have a lower decomposition temperature of 150° C. was used instead of 4.0 parts of azodicarbonamide as the blowing agent.

### Example 5

A sponge was produced as in Example 3 except that 1.5 parts of 2,5-dimethyl-2,5-di-t-butylperoxyhexane was added as an additional crosslinking agent.

### Example 6

A sponge was produced as in Example 5 except that 2,2′-azobis[N-(2-propenyl)-2-methylpropionamide] was used instead of 1,1′-azobis(cyclohexane-1-methylcarboxylate) as the blowing agent.

### Example 7

A sponge was produced as in Example 5 except that the amount of 1,1′-azobis(cyclohexane-1-methylcarboxylate) as the blowing agent was reduced from 3.0 parts to 0.5 part.

### Example 8

A sponge was produced as in Example 5 except that the amount of 1,1′-azobis(cyclohexane-1-methylcarboxylate) as the blowing agent was increased from 3.0 parts to 6.0 parts.

### Example 9

A sponge was produced as in Example 4 except that the amount of azodicarbonamide which had been modified with an organic zinc compound to have a lower decomposition temperature of 150° C. as the blowing agent was reduced from 4.0 parts to 1.0 part.

### Example 10

A sponge was produced as in Example 4 except that the amount of azodicarbonamide which had been modified with an organic zinc compound to have a lower decomposition temperature of 150° C. as the blowing agent was increased from 4.0 parts to 12.0 parts.

### Example 11

A sponge was produced as in Example 3 except that 0.5 part of bis-4-methylbenzoyl peroxide and 1.5 parts of 2,5-dimethyl-2,5-di-t-butylperoxyhexane were used instead of the addition crosslinker C-25A/C-25B as the crosslinking agent.

### Example 12

A sponge was produced as in Example 1 except that 17 parts of Denka Black (carbon black, Denki Kagaku Kogyo K.K.) was added to 100 parts of silicone rubber compound KE-551-U, which were fully kneaded on a Banbury mixer. To the mixture were added 3 parts of 1,1′-azobis(cyclohexane-1-methyl-carboxylate) and 8.0 parts of azodicarbonamide which had been modified with an organic zinc compound to have a lower decomposition temperature of 150° C. as the blowing agent, and 1.0 part and 2.0 parts of addition crosslinker C-25A and C-25B, respectively, and 1.5 parts of 2,5-dimethyl-2,5-di-t-butylperoxyhexane as the crosslinking agent.

### Comparative Example 1

A sponge was produced as in Example 1 except that only 8.0 parts of 1,1′-azobis(cyclohexane-1-methylcarboxylate) was used as the blowing agent.

### Comparative Example 2

A sponge was produced as in Example 1 except that only 20.0 parts of 1,1′-azobis(cyclohexane-1-methylcarboxylate) was used as the blowing agent.

### Comparative Example 3

A sponge was produced as in Example 1 except that only 4.0 parts of azodicarbonamide was used as the blowing agent.

### Comparative Example 4

A sponge was produced as in Example 1 except that only 4.0 parts of dinitrosopentamethylenetetramine was used as the blowing agent.

### Comparative Example 5

A sponge was produced as in Comparative Example 3 except that the amount of addition crosslinker C-25A (platinum catalyst) was increased from 1.0 part to 2.0 parts as the crosslinking agent.

### Comparative Example 6

A sponge was produced as in Comparative Example 5 except that 4.0 parts of azodicarbonamide which had been modified with urea to have a lower decomposition temperature of 150° C. was used instead of 4.0 parts of azodicarbonamide as the blowing agent.

### Comparative Example 7

A sponge was produced as in Comparative Example 5 except that 4.0 parts of azodicarbonamide which had been modified with an organic zinc compound to have a lower decomposition temperature of 150° C. was used instead of 4.0 parts of azodicarbonamide as the blowing agent.

### Comparative Example 8

A sponge was produced as in Comparative Example 6 except that 0.5 part of bis-4-methylbenzoyl peroxide and 1.5 parts of 2,5-dimethyl-2,5-di-t-butylperoxyhexane were used instead of the addition crosslinker C-25A/C-25B as the crosslinking agent.

### Comparative Example 9

A sponge was produced as in Comparative Example 8 except that the amount of bis-4-methylbenzoyl peroxide (organic peroxide crosslinking agent) was increased from 0.5 part to 1.0 part as the crosslinking agent.

### Comparative Example 10

A sponge was produced as in Comparative Example 6 except that 1.5 parts of 2,5-dimethyl-2,5-di-t-butylperoxy-hexane was added as an additional crosslinking agent.

### Comparative Example 11

A sponge was produced as in Comparative Example 10 except that the amount of azodicarbonamide which had been modified with an organic zinc compound to have a lower decomposition temperature of 150° C. as the blowing agent was increased from 4.0 parts to 8.0 parts.

### Comparative Example 12

A sponge was produced as in Example 1 except that 17 parts of Denka Black (carbon black) was added to 100 parts of silicone rubber compound KE-551-U, which were fully kneaded on a Banbury mixer. To the mixture were added 8.0 parts of azodicarbonamide which had been modified with an organic zinc compound to have a lower decomposition temperature of 150° C. as the blowing agent, and 1.0 part and 2.0 parts of addition crosslinker C-25A and C-25B, respectively, and 1.5 parts of 2,5-dimethyl-2,5-di-t-butylperoxyhexane as the crosslinking agent.

The results are shown in Tables 1 to 4.

TABLE 1

| Formulation | | Example | | | | | |
|---|---|---|---|---|---|---|---|
| (pbw) | | 1 | 2 | 3 | 4 | 5 | 6 |
| KE-551-U | | 100 | 100 | 100 | 100 | 100 | 100 |
| Blowing agent A | | 3 | 3 | 3 | 3 | 3 | |
| Blowing agent B | | | | | | | 3 |
| Blowing agent C | | 4 | | | | | |
| Blowing agent D | | | 4 | | | | |
| Blowing agent E | | | | 4 | | 4 | 4 |
| Blowing agent F | | | | | 4 | | |
| Carbon A | | | | | | | |
| C-25A/B | | 1.0/2.0 | 1.0/2.0 | 1.0/2.0 | 1.0/2.0 | 1.0/2.0 | 1.0/2.0 |
| PO crosslinker A | | | | | | 1.5 | 1.5 |
| PO crosslinker B | | | | | | | |
| Sponge | Hardness (Asker C) | 14 | 11 | 10 | 10 | 9 | 13 |
| state | Density (g/cm³) | 0.30 | 0.27 | 0.25 | 0.23 | 0.21 | 0.28 |
| | Cell state | micro- | micro- | micro- | micro- | micro- | micro- |
| | | cellular | cellular | cellular | cellular | cellular | cellular |
| | Cell size (μm) | 300 | 350 | 450 | 310 | 500 | 450 |

Miscellaneous

TABLE 2

| Formulation | | Example | | | | | |
|---|---|---|---|---|---|---|---|
| (pbw) | | 7 | 8 | 9 | 10 | 11 | 12 |
| KE-551-U | | 100 | 100 | 100 | 100 | 100 | 100 |
| Blowing agent A | | 0.5 | 6 | 3 | 3 | 3 | 3 |
| Blowing agent B | | | | | | | |
| Blowing agent C | | | | | | | |
| Blowing agent D | | | | | | | |
| Blowing agent E | | 4 | 4 | | | 4 | |
| Blowing agent F | | | | 1 | 12 | | 8 |
| Carbon A | | | | | | | 17 |
| C-25A/B | | 1.0/2.0 | 1.0/2.0 | 1.0/2.0 | 1.0/2.0 | — | 1.0/2.0 |
| PO crosslinker A | | 1.5 | 1.5 | | | 1.5 | 1.5 |
| PO crosslinker B | | | | | | 0.5 | |
| Sponge | Hardness (Asker C) | 7 | 18 | 27 | 1 | 31 | 2 |
| state | Density (g/cm³) | 0.20 | 0.31 | 0.37 | 0.11 | 0.30 | 0.15 |
| | Cell state | fine- | micro- | micro- | micro- | fine- | micro- |
| | | cellular | cellular | cellular | cellular | cellular | cellular |
| | Cell size (μm) | 900 | 250 | 200 | 500 | 700 | 320 |

| | |
|---|---|
| Miscellaneous | conductive |

TABLE 3

| Formulation | | Comparative Example | | | | | |
|---|---|---|---|---|---|---|---|
| (pbw) | | 1 | 2 | 3 | 4 | 5 | 6 |
| KE-551-U | | 100 | 100 | 100 | 100 | 100 | 100 |
| Blowing agent A | | 8 | 20 | 0 | 0 | 0 | 0 |
| Blowing agent C | | | | 4 | | 4 | |
| Blowing agent D | | | | | 4 | | |
| Blowing agent E | | | | | | | 4 |
| Blowing agent F | | | | | | | |
| Carbon A | | | | | | | |
| C-25A/B | | 1.0/2.0 | 1.0/2.0 | 1.0/2.0 | 1.0/2.0 | 2.0/2.0 | 2.0/2.0 |
| PO crosslinker A | | | | | | | |
| PO crosslinker B | | | | | | | |
| Sponge | Hardness (Asker C) | 48 | 50 | 58 | 55 | 73 | 71 |
| state | Density (g/cm³) | 0.60 | 0.78 | UM | UM | UM | UM |
| | Cell state | micro- | micro- | gas | gas | gas | gas |
| | | cellular | cellular | escape | escape | escape | escape |
| | Cell size (μm) | 60 | 50 | — | — | — | — |

| | | | | | | |
|---|---|---|---|---|---|---|
| Miscellaneous | high | high | surface | surface | surface | surface |
| | specific | specific | tack | tack | tack | tack |
| | gravity, | gravity, | | | | |
| | sponge | sponge | | | | |
| | fissure | fissure | | | | |

TABLE 4

| Formulation | | Comparative Example | | | | | |
|---|---|---|---|---|---|---|---|
| (pbw) | | 7 | 8 | 9 | 10 | 11 | 12 |
| KE-551-U | | 100 | 100 | 100 | 100 | 100 | 100 |
| Blowing agent A | | 0 | 0 | 0 | 0 | 0 | 0 |
| Blowing agent C | | | | | | | |
| Blowing agent D | | | | | | | |
| Blowing agent E | | | 4 | 4 | 4 | 8 | |
| Blowing agent F | | 4 | | | | | 8 |
| Carbon A | | | — | — | | | 17 |
| C-25A/B | | 2.0/2.0 | | | 2.0/2.0 | 2.0/2.0 | 1.0/2.0 |
| PO crosslinker A | | | 1.5 | 1.5 | 1.5 | 1.5 | 1.5 |
| PO crosslinker B | | | 0.5 | 1.0 | | | |
| Sponge | Hardness (Asker C) | 69 | 68 | 71 | 58 | 59 | 60 |
| state | Density (g/cm³) | UM | UM | UM | UM | UM | UM |
| | Cell state | gas | gas | gas | gas | gas | gas |
| | | escape | escape | escape | escape | escape | escape |
| | Cell size (μm) | — | — | — | — | — | — |

| | | | | | | |
|---|---|---|---|---|---|---|
| Miscellaneous | surface | surface | surface | surface | surface | surface |
| | tack | tack | tack | tack | tack | tack |

Note:
UM is unmeasurable.
PO crosslinker A: 2,5-dimethyl-2,5-di-t-butylperoxyhexane
PO crosslinker B: bis-4-methylbenzoyl peroxide
Carbon A: acetylene black

Rating of sponge state in Tables 1 to 4
Micro-cellular: spherical cells with thin walls, cell size less than 500 μm
Fine-cellular: spherical cells with thin walls, cell size 500-1000 μm
gas escape: blowing gas has escaped, cells have collapsed and are not spherical, substantially solid state
Sponge fissure: cells are good, but sponge looks fissured

For the organic foams described in Examples and Comparative Examples, a buildup of Mooney viscosity ML₁₊₄ is reported in Table 5.

TABLE 5
Mooney viscosity ML₁₊₄

| | | | Viscosity |
|---|---|---|---|
| | | | relative |
| | | | to viscosity |
| | viscosity | | (100) of |
| | at | viscosity | KE-551-U |
| | 40° C. | at | alone |
| Blowing agent | (unexpanded) | 170° C. | at 170° C. |
| KE-551-U alone | 37.5 | 13.7 | 100 |
| KE-551-U + Blowing agent A | 37.0 | 36.0 | 263 |
| KE-551-U + Blowing agent B | 35.6 | 37.4 | 273 |
| KE-551-U + Blowing agent C | 36.9 | 13.4 | 98 |
| KE-551-U + Blowing agent D | 36.3 | 13.3 | 97 |
| KE-551-U + Blowing agent E | 36.4 | 13.0 | 95 |
| KE-551-U + Blowing agent F | 36.5 | 13.3 | 97 |
| KE-551-U + Blowing agent G | 37.0 | 13.6 | 99 |

### Mooney Viscosity Measurement

Mooney viscosity was measured according to JIS K-6300. Using a viscometer RLM-1 (by Toyo Seiki Ltd.), a mixture of 100 parts of KE-551-U and 3 parts of organic blowing agent was analyzed.
Blowing agent A: 1,1′-azobis(cyclohexane-1-methyl-carboxylate), decomposition temperature ˜106° C.
Blowing agent B: 2,2′-azobis[N-(2-propenyl)-2-methyl-propionamide], decomposition temperature ˜69° C.
Blowing agent C: azodicarbonamide, decomposition temperature ˜204° C.
Blowing agent D: dinitrosopentamethylenetetramine, decomposition temperature ˜205° C.
Blowing agent E: azodicarbonamide+urea kicker, decomposition temperature ˜150° C.
Blowing agent F: azodicarbonamide+organic zinc compound kicker, decomposition temperature ˜150° C.
Blowing agent G: azobisisobutyronitrile, decomposition temperature ˜103° C.
Urea kicker: Celton N P by Sankyo Kasei Co., Ltd.

### Decomposition Temperature of Blowing Agent

Using an automatic gas volume meter Type CT-1, the decomposition temperature of a blowing agent was measured while heating a mixture of 1 g of blowing agent and 10 ml of DOP at a rate of 2° C./min.

### Measurement of Sponge Properties

A sponge was measured for hardness using Asker C type rubber hardness meter, for density (g/cm³) according to JIS K-6249, and for cell size (micrometer) as an average cell diameter in an area of 5 mm square (significant FIGS. 2). The cellular state of sponge was visually observed.

Japanese Patent Application No. 2007-051803 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A silicone rubber sponge composition comprising (A) 100 parts by weight of an organopolysiloxane having the average compositional formula (I):
R¹ₐSiO_{(4-a)/}_{²} (I)
wherein R¹ is each independently a substituted or unsubstituted monovalent hydrocarbon group and “a” is a positive number of 1.95 to 2.04,
(B) 0.1 to 20 parts by weight of a non-cyano organic azo blowing agent which is thermally decomposable to cause thickening or curing of component (A),
(C) 1 to 50 parts by weight of an azodicarbonamide blowing agent and/or dinitrosopentamethylenetetramine blowing agent, and
(D) a curing agent,
said composition being crosslinkable and expandable with atmospheric hot air.

2. The composition of claim 1 wherein the non-cyano organic azo blowing agent (B) is such that when a mixture of 100 parts by weight of component (A) and 3 parts by weight of component (B) is heated at 170° C. so that component (B) is thermally decomposed, the mixture becomes an organic foam having a buildup of Mooney viscosity ML₁₊₄ of at least 100% over the Mooney viscosity of component (A) alone.

3. The composition of claim 1 wherein the non-cyano organic azo blowing agent (B) comprises 1,1′-azobis(cyclohexane-1-methylcarboxylate).

4. The composition of claim 1, further comprising a kicker for facilitating decomposition of component (C) selected from the group consisting of urea, zinc oxide, an organic zinc compound, and mixtures thereof.

5. The composition of claim 1 wherein the curing agent (D) is an addition reaction curing agent consisting of a hydrosilylation catalyst and an organohydrogenpolysiloxane, an organic peroxide, or a combination of an addition reaction curing agent and an organic peroxide.

6. The composition of claim 1, further comprising (E) 1 to 60 parts by weight of conductive carbon for rendering the composition electrically conductive.

7. The composition of claim 1 which is cured to form a fully expanded silicone rubber sponge having a low density equal to or less than 0.3 g/cm³.
